(19) United States
(12) Patent Application Publication
(10) Pub. No.: US 2005/0066129 A1
(43) Pub. Date: Mar. 24, 2005

(54) Portable data storage device allowing dynamic setting of disk type and the method of dynamically setting disk type thereof

(76) Inventors: Chi-Tung Chang, Taipei County (TW); Hung-Chou Tsai, Nantou County (TW); Shih-Hsieng Yang, Taipei County (TW)

Correspondence Address: Chi-Tung Chang, Sec. 4,, 7F., No. 213, Civic Boulevard., Taipei, 105, TW

(21) Appl. No.: 10/670,839

(22) Filed: Sep. 22, 2003

(51) Int. Cl. G06F 12/00

(52) U.S. Cl. 711/115

(57) ABSTRACT

A portable data storage device allowing dynamic setting of disk type thereof includes a flash memory that includes at least two segments preset as a CD-ROM segment and a fixed type hard drive segment. When the portable data storage device is plugged in a processing unit of an electronic apparatus, one of the two segments having a non-applicable disk type is hidden depending on an operating system under which the processing unit operates, so that the processing unit may detect only another one of the two segments that has an applicable disk type. A method for dynamically setting an applicable disk type of the portable data storage device is also provided.

### FIELD OF THE INVENTION

The present invention relates to a portable data storage device, and more particularly to a portable data storage device allowing dynamic setting of disk type and a method for dynamically setting the disk type of the portable data storage device.

### BACKGROUND OF THE INVENTION

In response to the quick development and popularization of many advanced electronic apparatuses, such as computers, digital cameras, MP3 players, and various mobile devices, as well as varied types of information and transmission manners thereof, there is developed a variety of data storage devices (or storage media) to satisfy different demands.

Data storage devices developed in early stages may be generally divided into two types. The first type of data storage device is an electronic solid-state memory, such as read-only memory (ROM) and random access memory (RAM). This type of storage device is usually built in a computer. Unless it is non-erasable, it must be constantly supplied with power to keep the stored data. Thus, the first type of storage device does not meet the purpose of being conveniently portable. The second type of data storage device is a surface-based data storage device. Magnetic disks and compact disks are typical examples of the surface-based data storage devices. For this type of data storage device, data stored thereon must be accessed through a mechanical driving mechanism, such as a disk drive or a CD-ROM, and a memory capacity thereof is limited by a surface area thereof. In the case of a hard disk that has a relatively large memory capacity, a motor and a magnetic head are required to operate the hard disk. Other disadvantages of the surface-based data storage devices include having big volume, being non-resistant to shock, etc. Therefore, the second type of storage device does not meet the purpose of being conveniently portable, either.

In summary, a portable data storage device or storage medium should generally meet the following conditions:

1. Non-volatile: A main purpose of the portable data storage device is to allow free transferring or copying of stored data from an electronic apparatus to another different electronic apparatus, such as from a computer system to another computer system, from a digital camera to a computer system, or from a computer system to a personal digital assistant (PDA). Therefore, the ability of keeping stored data even when a power interruption occurs is a required feature of the portable data storage device.

2. Shock-resistant: Since the portable data storage device is often moved or carried in non-anticipated environments, it is very important for it to be highly shock-resistant and vibration-resistant. And, since movements of mechanical access, such as in the case of a hard disk drive, is very sensitive to shock and vibration, it is particularly important to reduce as much as possible movements of mechanical access to avoid the possibility of access error or machine failure.

3. High storage density: In consideration of good portability of and limited space available on a mobile device, such as the PDA, the portable data storage device must well take advantage of any and all space and be thin, short, light, and compact. Thus, it is very important for the portable data storage device to have high storage density.

4. Low power consumption: The portable data storage device is frequently used to transfer data between a computer system and a mobile device. It is known the mobile device is powered with batteries that have limited capacity while there are two major elements on the mobile device, namely, a processor and a display screen, that are highly power consumptive. Under this condition, there is only very limited power available for other peripherals of the mobile device. Thus, it is also very important for the portable data storage device to have low power consumption.

The solid-state non-volatile memory among the existing semiconductor memory components may be generally divided into several types, including mask read-only memory (MASK ROM), one-time programmable read-only memory (OTPROM), erasable programmable read-only memory (EPROM), electrically erasable programmable read-only memory (EEPROM), and flash memory. Wherein, the flash memory fully meets all the above-listed conditions and is therefore widely employed in the portable data storage device.

The flash memory may be differently designed to provide different memory arrays. Currently, there are several types of memory arrays available for use, including NOR, NAND, DINOR, and AND types. On the other hand, the flash memory may be functionally divided into two types, namely, code flash and data flash. The code flash is mainly configured with the NOR-type flash and generally used on products that do not require a large memory capacity, such as the BIOS (basic input and output system) for PC (personal computers), mobile phones, PDA, etc. On the other hand, the data flash is usually configured with the NAND-type flash and has a memory capacity normally larger than 16 MB, and is therefore suitable for storing and reading a large quantity of data, and using on digital cameras, MP3 players, computer systems, and various types of mobile devices to serve as a data storage device (or storage medium).

The following are some commercially available products of data flash being used as a portable data storage device or storage medium:

1. Multimedia Card (MMC): it is normally used on digital cameras, smart phones, MP3 players, etc.

2. Compact Flash Card (CF Card): it is normally used on digitalcameras, palm-top computers, MP3 players, PDA, etc.

3. Smart Media Card: it is normally used on digital cameras, palm-top computers, MP3 players, PDA, etc.

4. PC-ATA Flash Card (PC Card): it is normally used on notebook computers and electronic interpreters.

5. Memory Stick: it is mainly used on products manufactured by SONY.

6. Universal Serial Bus (USB) Flash Disk/USB Mass Storage Device: An example of this product is disclosed in Taiwanese New Utility Model Patent Publication No. 531028. It is normally used on computer systems or other electronic apparatuses having a USB port.

The above-mentioned various types of portable data storage devices may be sold independently, but are also frequently sold along with different processing apparatuses, such as notebook computers, desktop computers, palm-top computers, digital cameras, MP3 players, PDA, etc. With the popularization of more USB devices and wireless modular products, these portable data storage devices have become a new trend in the gift market and are frequently used as a means to represent a business or promote various products.

However, the currently available portable data storage devices have a disk type preset at the flash memory segment in the manufacturing plant, and may be, for example, a fixed type hard drive, a removable type disk, a CD-ROM, or other types of disks. When a user wants to use the conventional portable data storage devices having any one of these disk types, complicate and difficult procedures for installation and setup are required at the client to enable special functions, such as wireless connection to the Internet, automatic updating, running moving pictures, etc. Most consumers do not accept the conventional portable data storage device due to these complicate procedures for using it.

In the event the disk type preset at the flash memory segment for the conventional portable data storage device is, for example, a fixed type hard drive, the portable data storage device will be only workable under, for example, Windows XP to execute the switching of dynamic write-protect pins. When it is desired to use the same portable data storage device under other systems, it is necessary to re-plug these systems in the portable data storage device, and a flash memory about 32K must be used to create the hard disk. On the other hand, in the event the preset disk type is, for example, a removable type disk, the portable data storage device may support the switching of dynamic write-protect pins without wasting the flash memory to create the disk. However, when an electronic apparatus supports only one type of disk drive having a serial number, and the applied operating system thereof continuously detects the existence of the disk drive, the portable data storage device shall have slowed read/write speed and fail to support, for example, programs for auto-execution and other special functions.

While there are so many different operating systems available in the market, such as Windows 98, Windows ME, Windows XP, Windows 2000, etc., a conventional portable data storage device may be used for data transmission only under an operating system compatible with its disk type. That is, the conventional portable data storage device could not be dynamically set to different disk types in response to different operating systems and therefore has the drawbacks of, for example, limited applications, slowed read/write speed, requiring repeated plug-in, and not plug-and-play.

It is therefore desirable to develop an improved portable data storage device to overcome the above-mentioned drawbacks.

### SUMMARY OF THE INVENTION

A primary object of the present invention is to provide a portable data storage device allowing dynamic setting of disk type thereof, so that the portable data storage device may automatically detect and determine the operating system applied by the processing unit of an electronic apparatus to which the portable data storage device is connected, and then be automatically set to a specific disk type corresponding to the detected operating system.

Another object of the present invention is provide a method for dynamically setting a portable data storage device to a specific disk type corresponding to an operating system applied by the processing unit of an electronic apparatus to which the portable data storage device is connected.

A further object of the present invention is to provide a portable data storage device with which desirable special functions may be elastically enabled and executed.

The portable data storage device of the present invention may be plugged in an electronic apparatus to read and write data therefrom and thereinto, and mainly includes:
an interface unit for plugging in a processing unit of the electronic apparatus;
a flash memory into and from which data can be written and read, and being segmented into at least two segments particularly preset as a CD-ROM segment and a fixed type hard drive segment; and
a control unit located between and coupled with the interface unit and the flash memory to control input and output of data into and from the flash memory; when the interface unit is plugged in the processing unit, the control unit being adapted to identify an operating system under which the processing unit of the electronic apparatus operates and to hide one of the at least two segments of the flash memory that has a disk type not applicable to the operating system used by the processing unit, so that the processing unit may detect only the other one of the at least two segments that has an applicable disk type.

The method of the present invention for dynamically setting the disk type of the portable data storage device includes the following steps:
plugging the interface unit of the portable data storage device in the processing unit of the electronic apparatus, so that the control unit of the portable data storage device detects an operating system under which the processing unit of the electronic apparatus operates; and
hiding a segment on the flash memory of the portable data storage device that has a disk type not applicable to the operating system detected by the control unit, so that the processing unit may detect only another segment on the flash memory that has an applicable disk type.

In another embodiment of the present invention, the portable data storage device may be plugged in an electronic apparatus to read and write data therefrom and thereinto, and mainly includes:
an interface unit for plugging in a processing unit of the electronic apparatus;
a flash memory into and from which data can be written and read, and being segmented into at least three segments, namely, first, second, and third segments; the first and the second segment being preset as a CD-ROM segment and a fixed type hard drive segment, respectively, and the third segment being set as a removable type disk segment; and
a control unit located between and coupled with the interface unit and the flash memory to control input and output of data into and from the flash memory; when the interface unit is plugged in the processing unit, the control unit being adapted to identify an operating system under which the processing unit of the electronic apparatus operates and to hide one of the first and the second segments of the flash memory that has a disk type not applicable to the operating system used by the processing unit, so that the processing unit may detect only the other one of the first or the second segment that has an applicable disk type.

The above portable data storage device of the present invention may have a disk type dynamically set in a method including the following steps:
plugging the interface unit of the portable data storage device in the processing unit of the electronic apparatus, so that the control unit of the portable data storage device detects an operating system under which the processing unit of the electronic apparatus operates; and
hiding one of the first and the second segment on the flash memory of the portable data storage device that has a disk type not applicable to the operating system detected by the control unit, so that the processing unit may detect only another one of the first or the second segment on the flash memory that has an applicable disk type.

The above method for dynamically setting the disk type further includes a step of starting a special functional program internally built in the flash memory, and the special functional program may includes a start program for triggering the execution of an internal file.

With the portable data storage device of the present invention and the method for dynamically setting a disk type thereof, the portable data storage device may automatically detect the operating system at the host of the electronic apparatus in which it is plugged, and be dynamically set to different disk drive or CD-ROM depending on the detected operating system. The portable data storage device of the present invention may therefore be flexibly employed by users to perform different functions.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram for a portable data storage device according to the present invention;

FIG. 2 is a conceptual diagram explaining the structure and the use of the portable data storage device of the present invention;

FIG. 3 is a flowchart showing the steps of dynamically setting disk type of the portable data storage device of the present invention;

FIG. 4 is a conceptual view showing the portable data storage device of the present invention having been dynamically set to a first disk type; and

FIG. 5 is a conceptual view showing the portable data storage device of the present invention having been dynamically set to a second disk type.

### DETAILED DESCRIPTION OF THE PREFERRED EMBODIMENTS

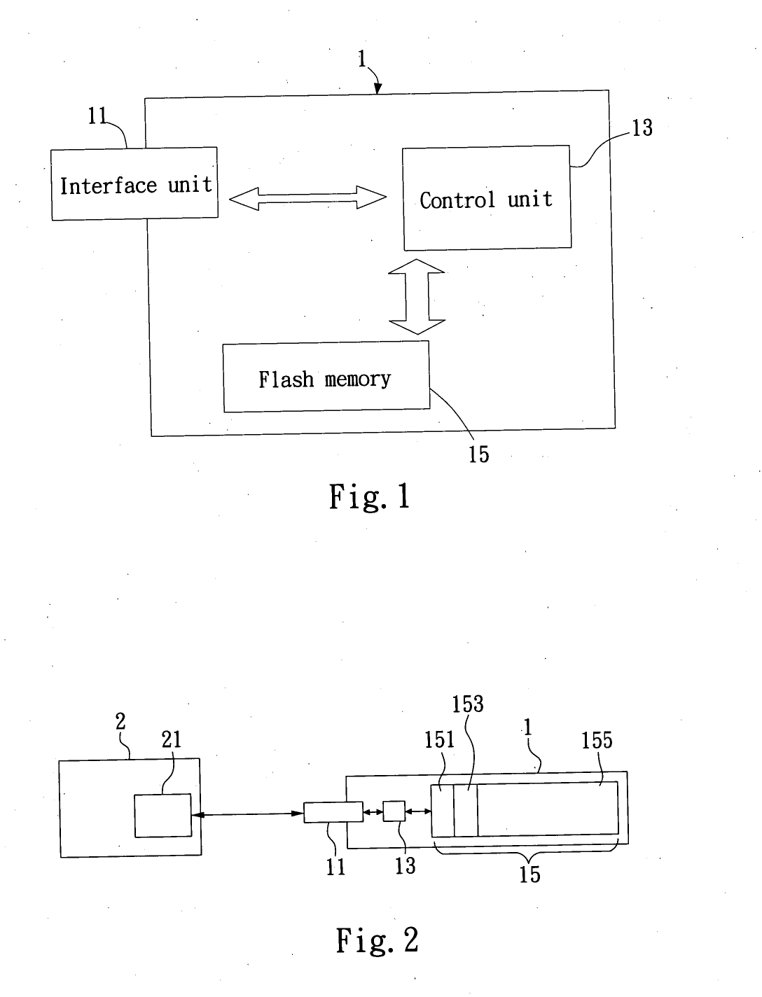

Please refer to FIG. 1 that is a block diagram for a portable data storage device 1 of the present invention. As shown, the portable data storage device 1 mainly includes an interface unit 11, a control unit 13, and a flash memory 15. The portable data storage device 1 of the present invention is configured to couple with an electronic apparatus, such as a computer, so that data stored in the portable data storage device 1 may be transferred to the electronic apparatus, and the electronic apparatus may execute the files and/or programs stored in the portable data storage device 1. Since the structure of the electronic apparatus does not constitute a feature of the present invention, and is not changed in any way for the purpose of the present invention, the following description emphasizes only on portions of the portable data storage device 1 that are most important to achieve the objects of the present invention, and descriptions of other portions are omitted without detriment to the wholeness of the present invention.

The portable data storage device 1 may be, for example, a USB flash disk or a USB mass storage device. However, it is understood that the portable data storage device of the present invention is not limited to the above-mentioned USB flash disk or USB mass storage device, but may otherwise be a multi-media card (MMC), a compact flash card (CF Card), a smart media card, a PC-ATA flash card (PC Card), a Memory Stick, or any other flash-memory-based portable data storage device or element.

As can be seen from FIG. 2, the interface unit 11 is selectively coupled with a processing unit 21 of an electronic apparatus 2, so that the electronic apparatus 2 may display, execute, read and/or write files stored in the portable data storage device 1. The processing unit 21 may operate under operating systems, such as Windows 98/ME/2000/XP provided by Microsoft. In the illustrated embodiment of the present invention, since the portable data storage device 1 may be, for example, a USB flash disk or a USB mass storage device, the interface unit 11 maybe, for example, a freely extendable connector adapted to connect to the electronic apparatus 2. Meanwhile, in the case the electronic apparatus 2 is, for example, a computer, the interface unit 11 may otherwise be a USB plug for coupling with a corresponding USB socket on the electronic apparatus 2. Of course, the interface unit 11 may be differently configured depending on a structure of the portable data storage device 1 or of the electronic apparatus 2 with which the interface unit 11 is coupled.

The control unit 13 is located between the interface unit 11 and the flash memory 15 to couple with them, so as to control the input and output of data to and from the portable data storage device 1. The control unit 13 may be, for example, a micro controller to include a read-only memory (ROM) for storing a control program, so as to do necessary management and control of the flash memory 15. Although the illustrated embodiment is described with a micro controller as the control unit 13, it is understood the control unit 13 may also be, for example, a firmware or other suitable element. Since the micro controller or the firmware is known in their actions and technical principles, they are not discussed in details herein.

The flash memory 15 has at least one file and/or program (not shown) stored therein, and is coupled with the control unit 13 for the latter to read and write data of the stored file and/or program. As can be seen from FIG. 2, the flash memory 15 in the illustrated embodiment is divided by way of segmentation into a first segment 151, a second segment 153, and a third segment 155. However, it is understood the flash memory 15 is not necessarily divided into three segments. In other words, the number of the segments may be changed or amended depending on actual needs.

The first segment 151 may be selectively set as a CD-ROM segment to include, for example, all source codes for a virtual CD-ROM and a special functional program (not shown). The special functional program may include a start program for executing an internal file. The start program may selectively include a special execution file and an application having driving mechanisms for playing an internal file. When the first segment 151 is set as a CD-ROM segment, such as a virtual CD-ROM, the firmware of the control unit 13 may emulate and restore these source codes to the processing unit 21 of the electronic apparatus 2, which uses an operating system, such as Windows 98/ME/2000/XP, developed by Microsoft. In this manner, a virtual CD-ROM existed in the portable data storage device 1 may be created, and the processing unit 21 is caused to identify the virtual CD-ROM as a real CD-ROM and automatically reads the special execution file under a root directory thereof. Since the contents and coding skills for all the source codes of the virtual CD-ROM are known, and not a part of the features of the present invention, they are not discussed herein.

The second segment 153 may be selectively set as a fixed type hard drive segment, and may also include the above-mentioned special functional program (not shown). The special functional program may include a start program for triggering and executing an internal file. The start program may selectively include a special execution file and an application having driving mechanisms for playing an internal file. When the second segment 153 is set as a fixed type hard drive segment, the control unit 13 may trigger the processing unit 21 of the electronic apparatus 2 to automatically search the start program or the special execution file under a root directory thereof. Since the coding skills for the start program or the special execution file are known, and not a part of the characteristics of the present invention, they are not discussed herein.

The above-mentioned special functional program may provide automatic execution of some special functions preset by a manufacturer. To ensure normal operation of such automatic execution function, both the first and the second segment 151, 153 may be set as read-only segments. Alternatively, the special functional program may be write-protected or erase-protected through an auto-decrypted encryption mechanism of the control unit 13.

The third segment 155 maybe selectively set as a removable type disk segment for a user to freely store or read data in or from the third segment 155. Meanwhile, the third segment 155 may also be used to store an internal file, such as an image file, a picture file, or a word data file, to be added on by the manufacturer to briefly introduce company profile and product.

The flash memory 15 in the illustrated embodiment is sequentially divided by way of segmentation into three types of predetermined segments, namely, a CD-ROM segment, a fixed type hard drive segment, and a removable type disk segment. However, it is understood the flash memory 15 is not necessarily divided into the three segments in the illustrated sequence but may be changed in their sequences. In other words, the number of the predetermined segments of the portable data storage device allowing dynamic setting of disk type 1 is not limited to three but may be changed or amended depending on actual needs.

In conclusion, the above arrangements have provided a unique portable data storage device allowing dynamic setting of disk type, which may be, for example, a USB flash disk or a USB mass storage device. And, a method of dynamically setting the disk type of the portable data storage device 1 depends on the operating system used by the processing unit 21 of the electronic apparatus 2 coupled with the portable data storage device 1. To more clearly describe the present invention, the dynamic setting of the portable data storage device 1 to two disk types will now be set forth.

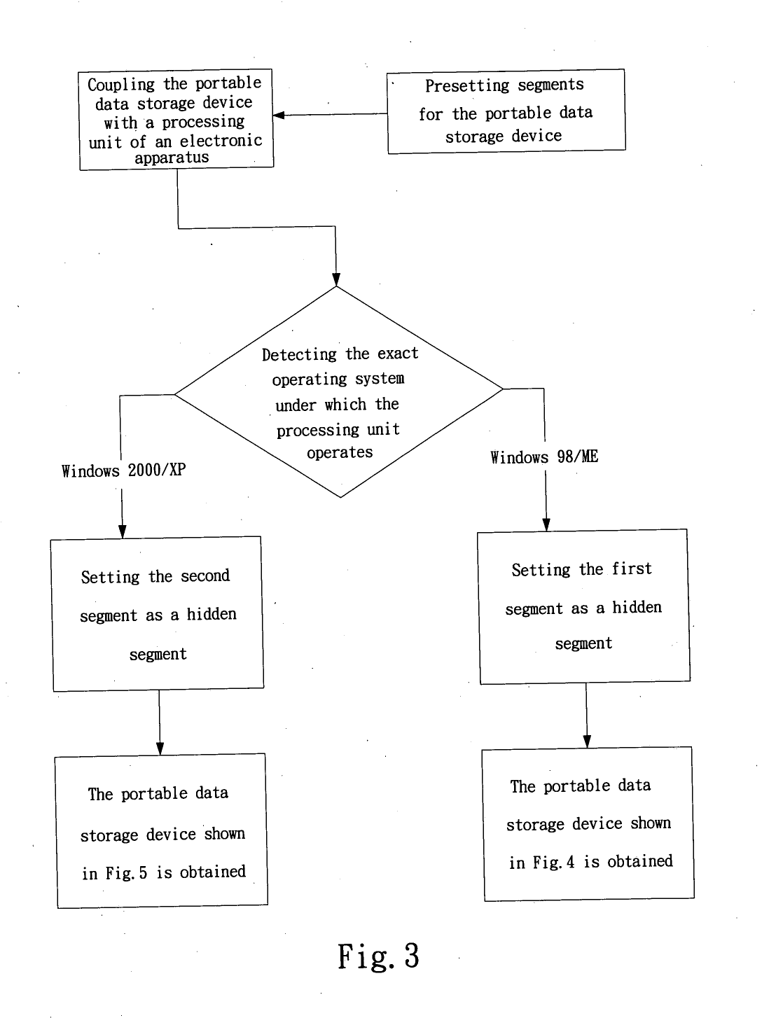

Please refer to FIG. 3 that is a flowchart showing the steps included in dynamically setting the disk type of the portable data storage device 1. As shown, in the first step, the interface unit 11 of the portable data storage device 1 is coupled with the processing unit 21 of the electronic apparatus 2, so that the control unit 13 of the portable data storage device 1 may detect the exact operating system under which the processing unit 21 of the electronic apparatus 2 works, and thereby determines and selects an applicable disk type, and the operating system will identify the disk type of the newly connected portable data storage device 1. Wherein, the operating system may be any one of Windows 98/ME/2000/XP developed by Microsoft.

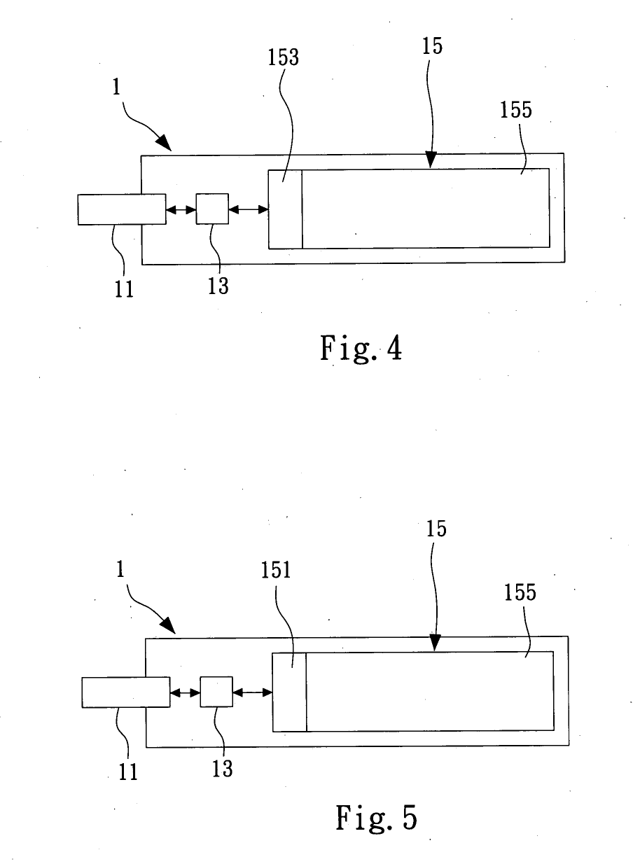

In the case the operating system under which the processing unit 21 operates is, for example, Windows 98 or ME, the first segment 151 may be selectively set as a hidden segment and the second segment 153 is reserved and set as a fixed type hard drive. Please refer to FIG. 4. After the interface unit 11 of the portable data storage device 1 is coupled with the processing unit 21 of the electronic apparatus 2 and the flash memory 15 of the portable data storage device 1 is dynamically set to hide the first segment 151, only the second segment 153 could be detected by the processing unit 21 as an applicable disk type. Meanwhile, the third segment 155 is still kept as a removable type disk. Therefore, the second segment 153 having been set as the fixed type hard drive allows the operating system to read and write at increased speed.

When the applied operating system of the processing unit 21 is, for example, Windows 2000 or XP developed by Microsoft, the second segment 153 may be selectively set as the hidden segment. In this manner, only the first segment 151 is set to the desired disk type (such as a CD-ROM segment) and reserved for use. Please refer to FIG. 5. When the interface unit 11 of the portable data storage device is coupled with the processing unit 21 of the electronic apparatus 2 and the flash memory 15 is dynamically set to hide the second segment 153, only the first segment 151 could be detected by the processing unit 21 as an applicable disk type. Meanwhile, the third segment 155 is still kept as a removable type disk. Therefore, the first segment 151 having been set to the CD-ROM segment allows the operating system to execute the switching of dynamic write-protect pins.

Since the second segment 153 set as the fixed type hard drive in FIG. 4 needs not to waste 32K of flash memory to create the virtual CD-ROM while it also supports the switching of dynamic write-protect pins, it may be applied to, for example, Windows 98/ME developed by Microsoft.

On the other hand, since the first segment 151 set as the CD-ROM segment in FIG. 5 allows the electronic apparatus 2 to operate the USB flash memory at the same time, and the operating system applied by the electronic apparatus 2 needs not to detect from time to time whether the portable data storage device 1 is still coupled with the electronic apparatus 2, it is applicable to, for example, Windows 2000/XP developed by Microsoft.

In other words, the first and the second segment 151, 153 may be set depending on different operating systems without being limited to that in the illustrated embodiments.

The above method of dynamically setting disk types further includes the step of using the set disk type to start special functional programs/files internally built in any segment of the flash memory. For example, for a wireless network provider, the special functional programs may be used to promote wireless connection to the Internet, so that the complicate and difficult procedures for installation and setup may be saved and users may have the convenience of plug and play; and for a software provider, since the present invention does not require an installation application, it allows the software provider to develop smaller and more practical software for it; and for an advertising agency, it would be easier to play an advertising picture because the advertising picture may be run and viewed by a user whenever the user plugs in the system; and for a network provider, the present invention allows a network user to automatically login a web site to update data thereof, and is particularly suitable for use by an on-line game dealer in managing points and by an advertising agency in updating pictures.

In the event the internal special functional program/file includes or is a service program, the service program will be automatically executed when the portable data storage device is coupled with (or plugged in) the processing unit of the electronic apparatus (or system), so that the service program is stored in the storage unit of the system (or the electronic apparatus). When a user operates or uses any file and requests for services, the service program provides a corresponding function to meet the users' request. With this new mechanism of providing an auto-executing service program, it is not necessary to run an installation program. For most manufacturers in the related industries, this is doubtlessly an important breakthrough in the computer-related field.

With the portable data storage device allowing dynamic setting of disk type and the disk type setting method according to the present invention, it is not only possible to maintain the non-volatility, shock resistance, high storage density, and low power consumption of the portable data storage device, but also solve many problems existed in the conventional portable data storage devices, such as failing to dynamically set disk types of the devices. The portable data storage device of the present invention is therefore improved and highly practical for use due to the following reasons:

1. It may be dynamically set to different disk types to correspond to the applied operating system without the need of selecting or operating or installing additional programs.

2. It may flexibly start a special function to be executed, and therefore facilitates the development of smaller and more practical software.

3. It may be conveniently carried and is a plug-and-play device.

4. It may automatically update data through the Internet.

1. A portable data storage device adapted to plug in an electronic apparatus for reading or writing data therefrom or thereinto, comprising:
an interface unit for plugging in a processing unit of said electronic apparatus;
a flash memory into and from which data can be written and read, and being segmented into at least two segments particularly set as a CD-ROM segment and a fixed type hard drive segment; and
a control unit located between and coupled with said interface unit and said flash memory to control input and output of data into and from said flash memory;
when said interface unit is plugged in said processing unit, said control unit being adapted to identify an operating system under which said processing unit of said electronic apparatus operates and to hide one of said at least two segments of said flash memory that has a disk type not applicable to said operating system used by said processing unit, so that said processing unit may detect only the other one of said at least two segments that has an applicable disk type.

2. The portable data storage device as claimed in claim 1, wherein said CD-ROM segment is hidden, so that only a disk type that is applicable to Windows 98/ME is used.

3. The portable data storage device as claimed in claim 1, wherein said CD-ROM segment includes all source codes for a virtual CD-ROM.

4. The portable data storage device as claimed in claim 2, wherein said CD-ROM segment includes all source codes for a virtual CD-ROM.

5. The portable data storage device as claimed in claim 3, wherein said CD-ROM segment has an internal file stored therein and internally includes a start program, and wherein said processing unit may detect said virtual CD-ROM in said CD-ROM segment via said control unit to locate a designated start program and automatically execute the play of said internal file.

6. The portable data storage device as claimed in claim 4, wherein said CD-ROM segment has an internal file stored therein and internally includes a start program, and wherein said processing unit may detect said virtual CD-ROM in said CD-ROM segment via said control unit to locate a designated start program and automatically execute the play of said internal file.

7. The portable data storage device as claimed in claim 5, wherein said CD-ROM segment is set as a read-only segment.

8. The portable data storage device as claimed in claim 6, wherein said CD-ROM segment is set as a read-only segment.

9. The portable data storage device as claimed in claim 1, wherein said fixed type hard drive segment is hidden, so that only a disk type that is applicable to Windows 2000/XP is used.

10. The portable data storage device as claimed in claim 1, wherein said fixed type hard drive segment has an internal file stored therein and internally includes a start program, and wherein said processing unit may be triggered via said control unit to locate a designated start program and automatically execute the play of said internal file.

11. The portable data storage device as claimed in claim 9, wherein said fixed type hard drive segment has an internal file stored therein and internally includes a start program, and wherein said processing unit may be triggered via said control unit to locate a designated start program and automatically execute the play of said internal file.

12. The portable data storage device as claimed in claim 10, wherein said fixed type hard drive segment is set as a read-only segment.

13. The portable data storage device as claimed in claim 11, wherein said fixed type hard drive segment is set as a read-only segment.

14. The portable data storage device as claimed in claim 1, wherein said interface unit comprises a USB plug for plugging in a corresponding USB socket on said electronic apparatus.

15. The portable data storage device as claimed in claim 1, wherein said control unit comprises a micro controller.

16. The portable data storage device as claimed in claim 15, wherein said micro controller includes a read-only memory for recording a control program.

17. A portable data storage device adapted to plug in an electronic apparatus for reading or writing data therefrom or thereinto, comprising:
an interface unit for plugging in a processing unit of said electronic apparatus;
a flash memory into and from which data can be written and read, and being segmented into at least three segments, namely, first, second, and third segments;
said first and said second segment being preset as a CD-ROM segment and a fixed type hard drive segment, respectively, and said third segment being set as a removable type disk segment; and
a control unit located between and coupled with said interface unit and said flash memory to control input and output of data into and from said flash memory; when said interface unit is plugged in said processing unit, said control unit being adapted to identify an operating system under which said processing unit of said electronic apparatus operates and to hide one of said first and second segments of said flash memory that has a disk type not applicable to said operating system used by said processing unit, so that said processing unit may detect only the other one of said first or the second segment that has an applicable disk type.

18. The portable data storage device as claimed in claim 17, wherein said CD-ROM segment is hidden, so that only a disk type that is applicable to Windows 98/ME is used.

19. The portable data storage device as claimed in claim 17, wherein said CD-ROM segment includes all source codes for a virtual CD-ROM.

20. The portable data storage device as claimed in claim 18, wherein said CD-ROM segment includes all source codes for a virtual CD-ROM.

21. The portable data storage device as claimed in claim 19, wherein said CD-ROM segment has an internal file stored therein and internally includes a start program, and wherein said processing unit may detect said virtual CD-ROM in said CD-ROM segment via said control unit to locate a designated start program and automatically execute the play of said internal file.

22. The portable data storage device as claimed in claim 20, wherein said CD-ROM segment has an internal file stored therein and internally includes a start program, and wherein said processing unit may detect said virtual CD-ROM in said CD-ROM segment via said control unit to locate a designated start program and automatically execute the play of said internal file.

23. The portable data storage device as claimed in claim 21, wherein said CD-ROM segment is set as a read-only segment.

24. The portable data storage device as claimed in claim 22, wherein said CD-ROM segment is set as a read-only segment.

25. The portable data storage device as claimed in claim 17, wherein said fixed type hard drive segment is hidden, so that only a disk type that is applicable to Windows 2000/XP is used.

26. The portable data storage device as claimed in claim 17, wherein said fixed type hard drive segment has an internal file stored therein and internally includes a start program, and wherein said processing unit may be triggered via said control unit to locate a designated start program and automatically execute the play of said internal file.

27. The portable data storage device as claimed in claim 25, wherein said fixed type hard drive segment has an internal file stored therein and internally includes a start program, and wherein said processing unit may be triggered via said control unit to locate a designated start program and automatically execute the play of said internal file.

28. The portable data storage device as claimed in claim 26, wherein said fixed type hard drive segment is set as a read-only segment.

29. The portable data storage device as claimed in claim 27, wherein said fixed type hard drive segment is set as a read-only segment.

30. The portable data storage device as claimed in claim 17, wherein said interface unit comprises a USB plug for plugging in a corresponding USB socket on said electronic apparatus.

31. The portable data storage device as claimed in claim 17, wherein said control unit comprises a micro controller.

32. The portable data storage device as claimed in claim 31, wherein said micro controller includes a read-only memory for recording a control program.

33. A method of dynamically setting a disk type of a portable data storage device claimed in claim 1, comprising the steps of:
plugging an interface unit of said portable data storage device in a processing unit of an electronic apparatus, so that a control unit of said portable data storage device detects an operating system under which said processing unit of said electronic apparatus operates; and
hiding a segment on a flash memory of said portable data storage device that has a disk type not applicable to said operating system detected by said control unit, so that said processing unit may detect only another segment on said flash memory that has an applicable disk type.

34. The method as claimed in claim 33, wherein a CD-ROM segment on said flash memory is hidden when said detected operating system is Windows 98/ME, so that said processing unit may detect only said another segment that is a fixed type hard drive segment having the applicable disk type.

35. The method as claimed in claim 33, wherein a fixed type hard drive segment on said flash memory is hidden when said detected operating system is Windows 2000/XP, so that said processing unit may detect only said another segment that is a CD-ROM segment having the applicable disk type.

36. The method as claimed in claim 33, further comprising a step of enabling a special functional program internally built in said flash memory.

37. The method as claimed in claim 36, wherein said special functional program comprises a start program for executing an internal file.

38. A method of dynamically setting a disk type of a portable data storage device claimed in claim 17, comprising the steps of:
plugging an interface unit of said portable data storage device in a processing unit of an electronic apparatus, so that a control unit of said portable data storage device detects an operating system under which said processing unit of said electronic apparatus operates; and
hiding one of a first and a second segment on a flash memory of said portable data storage device that has a disk type not applicable to said operating system detected by said control unit, so that said processing unit may detect only another one of said first or said second segment on said flash memory that has an applicable disk type.

39. The method as claimed in claim 38, wherein a CD-ROM segment on said flash memory is hidden when said detected operating system is Windows 98/ME, so that said processing unit may detect only said another segment that is a fixed type hard drive segment having the applicable disk type.

40. The method as claimed in claim 38, wherein a fixed type hard drive segment on said flash memory is hidden when said detected operating system is Windows 2000/XP, so that said processing unit may detect only said another segment that is a CD-ROM segment having the applicable disk type.

41. The method as claimed in claim 38, further comprising a step of enabling a special functional program internally built in said flash memory.

42. The method as claimed in claim 41, wherein said special functional program comprises a start program for executing an internal file.
